(19) United States
(12) Patent Application Publication
(10) Pub. No.: US 2004/0143506 A1
(43) Pub. Date: Jul. 22, 2004

(54) Method of selecting and digitally recording items to form a personalized compact disk

(76) Inventor: Robert P. Goldman, Bethesda, MD (US)

Correspondence Address: STAMATIOS MYLONAKIS, 7009 CASHELL MANOR COURT, DERWOOD, MD, 20855-1201, US

(21) Appl. No.: 10/346,091

(22) Filed: Jan. 17, 2003

(51) Int. Cl. G06F 17/60

(52) U.S. Cl. 705/26

(57) ABSTRACT

A recording system and method where a Customer Communication Unit transmits an order to a Central Unit, where the Central Unit retrieves the ordered item from the database and records same on a CD, DVD or MP3 recording.

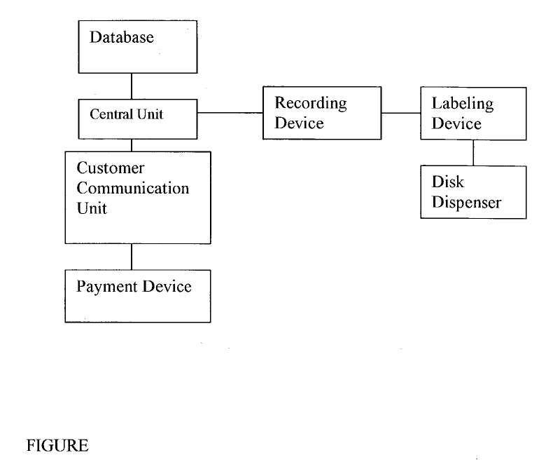

### BACKGROUND OF THE INVENTION

1. Field of the Invention

The present Application relates to a convenient method of forming a personalized recorded disk such as a Compact Disk (CD), Digital Video Disk (DVD) or a MP3 recording.

2. Discussion of the Related Art

The technology of making CD and DVD recordings is known. It is further known the methods for recording an entire CD, DVD or MP3 recording or selected parts of a CD, DVD or MP3 recording into a new blank CD, DVD or MP3 recording.

### SUMMARY OF THE INVENTION

The present invention relates to a recording system comprising at least one central unit, access to at least one database unit, and at least one customer communication unit. The central unit is configured to transmit and receive information from the customer communication unit and the database, and to transmit information to a recording unit, which recording unit is configured to record on a CD, DVD or MP3. The customer communication unit is configured to enter and receive information from the central unit related to at least one order and to receive and transmit information from a payment device related to a credit card or cash input, and to transmit same to the central unit.

### BRIEF DESCRIPTION OF THE DRAWING

The FIGURE shows flowchart for one embodiment in accordance with the present invention.

### DESCRIPTION OF THE PREFERRED EMBODIMENTS

In accordance with the present invention the customer is given an automated way to create a CD, a DVD or a MP3 recording through an access to a high speed database, to either combine a mix of music that a recording device will record onto a CD, DVD or MP3 recording or download the entire album of a recording. These recording devices could be located at any location that could provide high speed data transfer. Further, the information with the database is exchanged via the Internet facility, an intranet facility or a stand alone database.

In one embodiment in accordance with the present invention the customer communication unit comprises a keyboard and a monitor connected to the central unit. In a preferred embodiment the central unit, the customer communication unit, the payment device, the recording device, the labeling device and the disk dispenser are housed in one case or cabinet hereinafter call “machine”.

Accordingly, a person could use one of the above recording devices and make a CD, DVD or MP3 recording of either the latest artist's recordings, by downloading the entire album, or record a portion of one artist's new selections and add selections from other albums from the same artist or mix a selection from various different artists. The selections would be downloaded to a high speed Compact Disc Read and Write (CDRW)/DVD recorder which would record the selections onto a CD, DVD or MP3 recording and deliver it into a slot for the customer. A printer will make a label listing the customer's selection. It will also drop into a slot and come out, preferably with a case to be combined with the recorded CD, DVD or MP3 recording. Each machine would have access for credit card and/or cash input for payment. The machine would have access to a large database selection of music and could be placed in any location. The recording device of the present invention would alleviate the need for huge stocks of CD, DVD or MP3 recordings, as any CD, DVD or MP3 recording could be electronically chosen and made by the customer in a brief time. Each machine would preferably have a high speed computer processor, a keyboard access to a digital database for choices; each customer could choose a certain number of selections to record on to a CD, DVD or MP3 recording for a set price. The term “high speed” is used herein to denote real time transmissions with a processor of higher than 1 GHz, preferably higher than 2 GHz.

The recording device would allow customers an unparalleled way to create their own choices of music and record them on a CD, DVD or MP3 recording which would play on customer's CD, DVD or MP3 recording player. The customers can do what they never could do commercially before, create custom CDs or DVDs of licensed artists without violating copy writes or patents.

Having generally described this invention, a further understanding can be obtained by reference to certain specific examples which are provided herein for purposes of illustration only and are not intended to be limiting unless otherwise specified.

On the bases of an illustrative embodiment, a customer initiates a search from the Customer Communication Unit, equipped with a keyboard and a monitor connected to a search engine via the Central Unit, to identify a file, containing at least one song, in the Database he/she would like to include on a CD. When the desired file is identified the Central Unit sends a message to the customer asking whether the customer would like to add the file to the disk. If the customer agrees to order the file the Central Unit stores the selection into a temporary memory. When enough files have been added to fill a disk the Central Unit informs the customer and asks whether he/she would like to start another disk or place the order. If the customer decides to place the order the Central Unit requests that the customer selects a payment method, from a credit card or cash. After the customer's selection of payment the Central Unit requests the customer to insert the credit card or cash, at the location provided at the Payment Device. When payment is made the Central Unit transmits the file selections to the Recording Device, where a CD is created, labeled with the selected files by the Labeling Device and is dispensed by the Disk Dispenser to be picked up by the customer.

Obviously, numerous modifications and variations of the present invention are possible in light of the above teachings. It is therefore to be understood that within the scope of the appended claims, the invention may be practiced otherwise than as specifically described herein.

1. A recording system, comprising: at least one central unit, said central unit configured to communicate with at least one database unit, and at least one customer communication unit;
wherein said central unit is configured for real time interactive exchange of information with the customer communication unit and the database unit, and transmit information to a recording unit, said recording unit being configured to record on a CD a DVD or a MP3; and
wherein said customer communication unit is configured to exchange information with the central unit related to at least one order and for interactive exchange of information, related to a credit card or cash input, with a payment device, and transmit same to the central unit.

2. A method for operating a recording system, comprising at least one central unit, said central unit configured to communicate with at least one database unit, at least one customer communication unit, and a payment devise configured to communicate with the central unit, comprising:
transmitting from the customer communication unit at least one order to the central unit for at least one item;
receiving at the customer communication unit a request for payment;
transmitting payment information from the payment devise to the central unit;
exchanging order information between the central unit and the database;
recording a CD, DVD or MP3, labeling said CD, DVD or MP3 recording and dispersing said CD, DVD or MP3 recording containing the requested item.

3. The recording system of claim 1, wherein the database is in the internet facilitated via the information with the database is exchanged via an Internet facility, an intranet facility or a stand alone database.

4. The recording system of claim 1, wherein more than one of the central unit, the customer communication unit, the recording device, the labeling device and the disk dispenser are house in one case.
